(19) United States
(12) Patent Application Publication
(10) Pub. No.: US 2026/0251272 A1
(43) Pub. Date: Aug. 27, 2026

(54) Elastic Contact Terminal for the End of a Lamp, and a Lamp Comprising the Same

(71) Applicants: Self Electronics Co., Ltd., Ningbo (CN); Self Electronics USA Corporation, Norcross, GA (US)

(72) Inventors: Feng Ji, NINGBO (CN); Zhaoyong Zheng, NINGBO (CN)

(21) Appl. No.: 19/650,819

(22) Filed: Apr. 17, 2026

Related U.S. Application Data
(63) Continuation of application No. PCT/CN2025/145395, filed on Dec. 25, 2025.

(30) Foreign Application Priority Data
Jan. 3, 2025 (CN) 202510011723.X

(51) Int. Cl. F21S 4/28; F21V 23/06; H01R 13/05; F21Y 103/10

(52) U.S. Cl. CPC F21S 4/28; F21V 23/06; H01R 13/05; F21Y 2103/10

(57) ABSTRACT

An elastic contact terminal for the end of a lamp has a plug-in frame adapted to fittingly connect to the end of a lamp housing; two conductive resilient pieces are arranged at intervals in the plug-in frame; the conductive resilient pieces extend lengthwise along the housing, and their length is greater than that of the plug-in frame, with each piece having a latching member exposed out of the plug-in frame. The latching members of the two conductive resilient pieces are configured to be displaced relative to each other to expand and contract. Resilient elements are abutted against the opposite inner sides of the latching members, and the deformation restoring force of the resilient elements urges the latching members outward.

### FIELD OF THE TECHNOLOGY

The present application relates to the field of lamps, in particular to a lamp and an elastic contact terminal at its end.

### BACKGROUND

Due to the compactness of product space, the spring contact terminals which are used for small lamps are often difficult to design into large or complex structures, and that directly leads to insufficient elasticity performance. During long-term use, the spring contact terminals are prone to permanent deformation under frequent mechanical stress, which in turn results in reduced contact area and insufficient contact performance. When the pressure between the contact terminals is insufficient to maintain stable electrical contact, the current transmission will be affected, ultimately causing the lamp to fail to work and light normally. This problem not only affects users' normal experience but also may bring about potential safety hazards.

Therefore, how to design a reliable and cost-effective spring contact terminal within a limited space has become an urgent technical problem to be solved in the field of small lamp design and manufacturing.

In view of this, technicians in the field are committed to developing a lamp and an elastic contact terminal at its end, aiming to solve the problems of insufficient elasticity and permanent deformation of spring contact terminals of small lamps caused by long-term use.

### BRIEF SUMMARY THE TECHNOLOGY

In view of the above-mentioned defects of the prior art, the technical problem to be solved by this application is the problems of insufficient elasticity and permanent deformation of spring contact terminals in existing small-sized lamps caused by long-term use.

To achieve the above objective, in a first aspect, the present application provides an elastic contact terminal for the end of a lamp, comprising a plug-in frame adapted to be fittingly connected to the end of a lamp housing. Two conductive resilient pieces are arranged at intervals in the plug-in frame. The conductive resilient pieces extend along the length direction of the housing, and the length of the conductive resilient pieces is greater than that of the plug-in frame, with each conductive resilient piece including a latching member exposed out of the plug-in frame. The latching members of the two conductive resilient pieces are configured to be displaced relative to each other to expand and contract to latch and release. Each of the opposite inner sides of the latching members is in contact with a resilient element, and the deformation restoring force of the resilient element keeps the latching members in a tendency to expand outward.

In an optional embodiment, each conductive resilient piece comprises a fixed portion and a movable portion. The fixed portion is fixedly mounted in mating engagement with the plug-in frame, and the movable portion is connected between the fixed portion and the latching member along the length direction. The plug-in frame is provided with a clearance for the movement of the movable portion, enabling the movable portion to swing in the width direction.

In an optional embodiment, the plug-in frame comprises a base plate and mounting walls. The base plate is arranged to extend along the length direction of the housing, the conductive resilient pieces are fittingly mounted on the base plate, and the mounting walls are vertically arranged on both sides of the base plate and fittingly connected to the inner side of the housing.

In an optional embodiment, a protruding spacing rib is arranged on the base plate, and the spacing rib extends along the length of the housing. The two conductive resilient pieces are respectively mounted on opposite sides of the spacing rib and positioned between the spacing rib and the respective mounting walls. One resilient element is disposed on each side and abuts against the spacing rib and the corresponding conductive resilient piece.

In an optional embodiment, each of the opposite sides of the two latching members along the width direction is formed with an inner notch, and a resilient elements abuts against the inner notch to urge the respective latching member to expand outward. A clearance recess extends from the inner notch in a direction away from the end of the latching member, and is configured to provide accommodation spaces for the resilient element when the resilient element is compressed and deformed.

In a preferred embodiment, the middle part of each resilient element is provided with a bending portion configured to abut against the inner notch of the latching member. One end of the resilient element is a support leg configured to establish a supporting point in the plug-in frame, and the other end is a movable leg configured to move within the clearance recess as the resilient element undergoes elastic deformation. The resilient element is arranged to be capable of expanding under force and has a tendency to make the movable leg approach the end of the support leg under the action of deformation restoring force.

In an optional embodiment, each clearance recess comprises one or more inclined surfaces extending from the latching member toward the fixed portion, such that the radial dimension of the movable portion is smaller than that of the fixed portion.

In an optional embodiment, the plug-in frame is further provided with a cover plate. The cover plate and the base plate engage to form accommodation spaces for isolating the two conductive resilient pieces respectively, and meanwhile provide supporting points for the resilient elements.

In a second aspect, the present application further provides a strip lamp, comprising a strip-shaped housing. An opening is provided at an end of the housing along the length direction, and a circuit board is fixedly assembled inside the housing. The elastic contact terminal as described above is mounted at the end of the housing. The conductive resilient pieces are electrically connected to the circuit board inside the housing, and the latching members are exposed outside the housing.

In an optional embodiment, the tail part of each conductive resilient piece is provided with a pin extending inside the housing along the length direction. The end of the pin of each conductive resilient piece is inserted into a connection hole on the circuit board respectively, so as to be electrically connected to either the positive or the negative circuit of the circuit board.

In an optional embodiment, the housing comprises a bottom plate and two side walls. An assembly groove is provided on the inner side of each side wall, and a plug-in strip adapted to the assembly groove is provided on the outer side of the plug-in frame. A wire groove is comprised in the assembly groove on each side, and a conductive strip is assembled along the wire groove inside the housing. The middle part of each conductive resilient piece is provided with a lateral extension part extending laterally and outwards from the plug-in frame. After the plug-in frame is assembled, the conductive resilient piece on each side is electrically connected to the conductive strip via the lateral extension part.

In an optional embodiment, the conductive resilient pieces and the conductive strips are located on the same mounting plane, and a side of the lateral extension part facing the tail part of the conductive resilient piece is provided with an inwardly inclined guide surface.

The technical effects of the present invention:

The present application proposes a new solution aiming to solve the problems of insufficient elasticity and permanent deformation of spring contact terminals of small lamps caused by long-term use. By skillfully arranging the resilient piece structure inside the plug-in frame, the present application can automatically provide a strong restoring force when the conductive resilient pieces are deformed. This design not only ensures continuous and effective contact between the conductive resilient pieces and the conductive strips, but also significantly improves the reliability and service life of the lamp.

In addition, the conductive resilient piece has a simple structure, which is easy to manufacture and install, thus greatly reducing the production cost. The present application not only solves the existing problems in the prior art, but also has high practicability and economy, bringing new ideas and technical breakthroughs to the design and production of small lamps.

### BRIEF DESCRIPTION OF THE DRAWINGS

Embodiments of the present invention will be described below with reference to the drawings, in which:

FIG. 1 is a schematic structural diagram of the elastic contact terminal at an end of a lamp of the present application.

FIG. 2 is a schematic diagram of the internal structure of the lamp shown in FIG. 1.

FIG. 3 is a schematic structural diagram of the elastic contact terminal of the present application.

FIG. 4 is a schematic exploded structure diagram of the structure shown in FIG. 3.

FIG. 5 is a schematic longitudinal sectional structural diagram of an embodiment of the lamp of the present application.

FIG. 6 is a schematic structural diagram of the bottom of the lamp of the present application.

### DETAILED DESCRIPTION OF THE INVENTION

Specific embodiments of the present disclosure will be further described in detail below based on the accompanying drawings. It should be understood that the description of the embodiments of the present disclosure herein is not intended to delimit the protection scope of the present disclosure.

The terms used in the following embodiments are intended only to describe the purpose of a particular embodiment and are not intended to limit this disclosure. The terms “one”, “a” and “this” of singular forms used in this specification and the appended claims of this disclosure are also intended to include plural forms, unless otherwise specified in the context clearly. It should also be understood that in the following embodiments of this disclosure, “at least one” and “one or more” mean one or two or more. The term “and/or” describes an association relationship for describing associated objects and represents that three relationships may exist. For example, A and/or B may represent the following three cases: Only A exists, both A and B exist, and only B exists, where A and B may be singular or plural. The character “/” generally indicates an “or” relationship between the associated objects.

Reference to “one embodiment”, “some embodiments” or the like described in this specification means that one or more embodiments of this disclosure include a particular feature, structure, or characteristic described with reference to the embodiment. Therefore, the expressions “in one embodiment”, “in some embodiments”, “in some other embodiments” that appear in different parts of this specification do not necessarily mean reference to the same embodiment, but mean “one or more embodiments but not all embodiments”, unless otherwise specially emphasized. The terms “include”, “comprise”, “have”, and variations thereof mean “include, but are not limited to”, unless otherwise specifically emphasized.

The present application is described in further detail below with reference to the embodiments shown in the accompanying drawings.

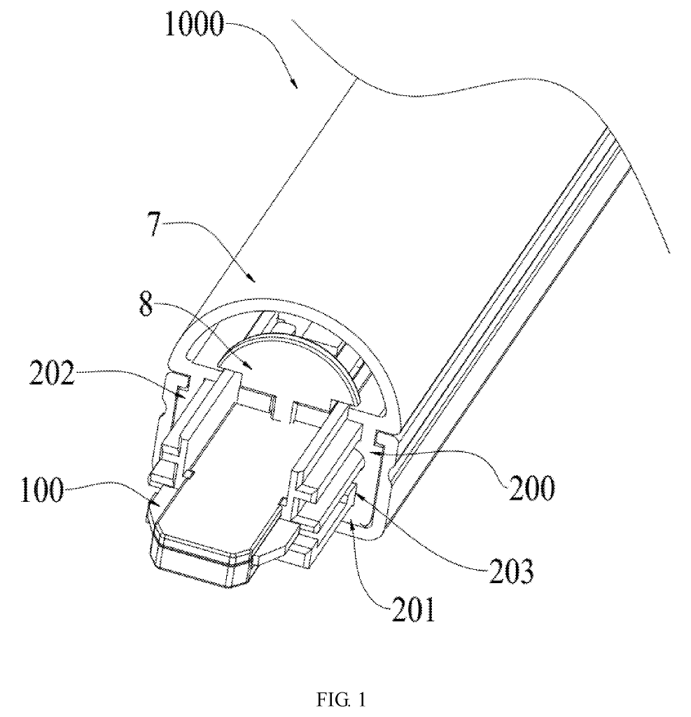

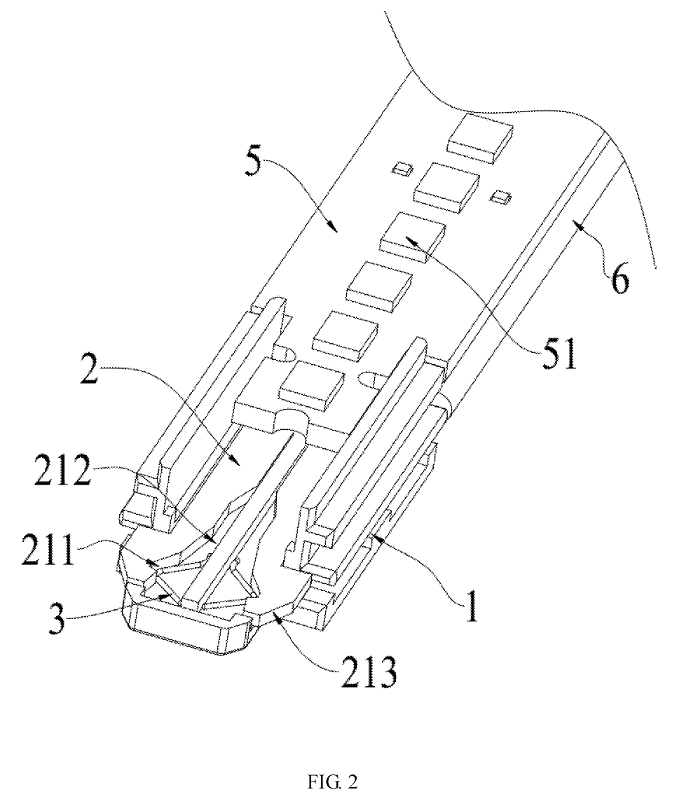

In a first aspect of the present application, there is provided an elastic contact terminal for the end of a lamp 1000, which comprises a plug-in frame 1. As shown in FIG. 1, the terminal is adapted to be fittingly connected to the end of a housing 200 of the lamp 1000. The housing 200 extends along the length direction and is provided with an opening at the end, and the elastic contact terminal 100 of the present application is connected to the housing 200. The plug-in frame 1 extends in the same direction as the lamp housing. Conductive resilient pieces 2 are arranged at intervals in the plug-in frame 1, and the conductive resilient pieces 2 extend along the length direction of the housing 200. The length of the conductive resilient pieces 2 is greater than that of the plug-in frame 1, and each conductive resilient piece 2 comprises a latching member 21 exposed out of the plug-in frame 1. The conductive resilient pieces 2 are used for connecting the positive and negative circuits, and generally two pieces are provided. Further, they are arranged at intervals in the plug-in frame 1 to achieve electrical isolation. The latching members 21 of the two conductive resilient pieces 2 are configured to be displaced relative to each other to expand and contract for latching (engagement) and releasing (disengagement). As shown in FIG. 2, each of the opposite inner sides of the latching members 21 is in contact with a resilient element 3, and the deformation restoring force of the resilient elements 3 keeps the latching members 21 in a tendency to expand outward. According to the above structure, when the end of the elastic contact terminal 100 of the present application is interconnected, the latching members 21 expand outward to achieve stable interconnection with other external housing structures of the same type.

Each conductive resilient piece 2 comprises a fixed portion 22 and a movable portion 23. The fixed portion 22 is fixedly mounted in mating engagement with the plug-in frame 1, and the movable portion 23 is connected between the fixed portion 22 and the latching member 21 along the length direction. The plug-in frame 1 is provided with a movement clearance for the movable portion 23, enabling the movable portion 23 to swing in the width direction. The conductive resilient piece 2 may be an integrated elastic metal sheet formed by processing. The conductive resilient pieces 2 are resilient and capable of bending deformation. After the two conductive resilient pieces 2 are mounted, under an externally applied inward force, the two movable portions 23 swing inward, causing the latching members 21 connected to their front ends to draw close inward, and the radial width thereof is reduced to facilitate installation. Subsequently, under the action of the restoring force of the resilient elements 3, the latching members 21 expand outward, driving the two movable portions 23 to swing outward. In this way, the two conductive resilient pieces 2 move on different sides along their mounting plane. Preferably, the latching members 21 move telescopically in the width direction with the swing of the movable portions 23, with the parts exposed out of the plug-in frame 1 moving accordingly.

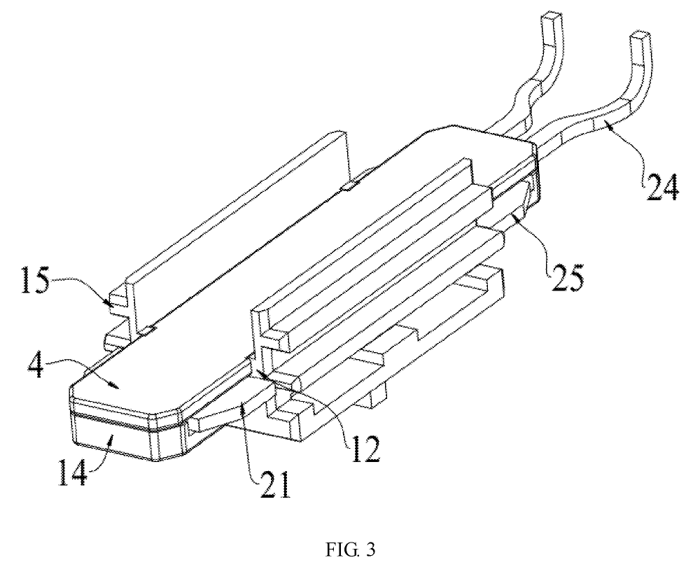

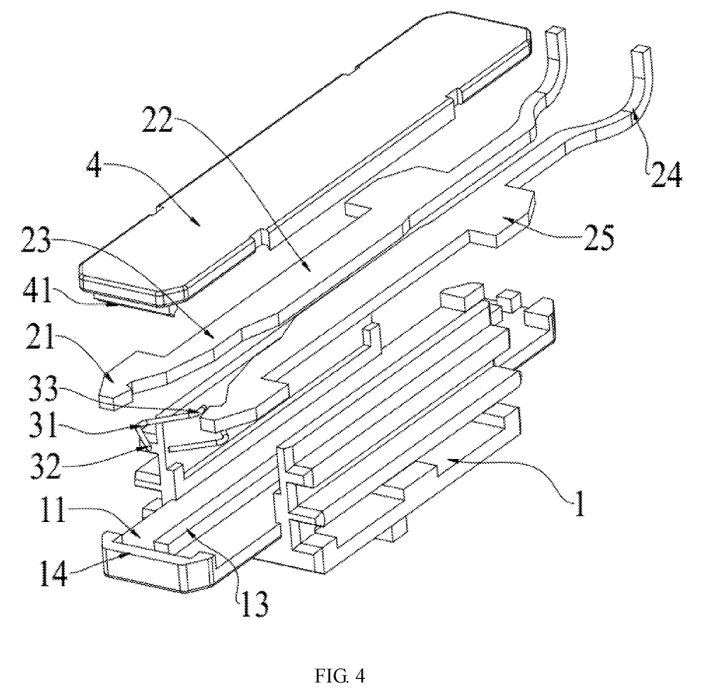

FIGS. 3 and 4 are schematic structural diagrams of the elastic contact terminal. The plug-in frame 1 comprises a base plate 11 and mounting walls 12. The base plate 11 extends transversely along the length direction of the housing 200 and is suitable for mounting the conductive resilient pieces 2. The mounting walls 12 are vertically arranged on both sides of the base plate 11 and fittingly connected to the inner side of the housing 200. A protruding spacing rib 13 is arranged on the base plate 11, and the spacing rib 13 extends along the length of the housing 200 to separate the mounting space on the base plate 11. The two conductive resilient pieces 2 are respectively mounted on opposite sides of the spacing rib 13 and positioned between the spacing rib 13 and the respective mounting walls 12. The resilient elements 3 abut against the spacing rib 13 and the conductive resilient pieces 2.

Each of the opposite sides of the two latching members 21 along the width direction is formed with an inner notch 211. Each resilient element 3 abuts against the corresponding inner notch 211, thus urging the latching members 21 of the two sides to expand outward. Meanwhile, the inner notch 211 provides space for positioning part of the structure of the resilient element 3, preventing the resilient element 3 from disengaging during movement. At the same time, a clearance recess 212 is formed extending from the inner notch 211 in a direction away from the end of the latching member 21, and the clearance recess 212 provides accommodation space for the resilient element 3 when the resilient element 3 is compressed and deformed. When the resilient element 3 is compressed and deformed under force, a part thereof is clamped in the inner notch 211, and the extended part deforms and performs telescopic displacement within the clearance recess 212.

In a specific embodiment of the present application, the resilient element 3 is configured as an elongated metal part, and in particular, may optionally be a metal strip or a metal wire. The middle part of each resilient element 3 is provided with a bending portion 31. In use, the bending portion 31 abuts against the inner notch 211 of the latching member 21. One end of the resilient element 3 is a support leg 32 configured to establish a supporting point in the plug-in frame 1, and the other end is a movable leg 33 configured to move within the clearance recess 212 as the resilient element 3 undergoes elastic deformation. The resilient element 3 is arranged to be capable of expanding under force and has a tendency to make its two ends approach each other under the action of deformation restoring force. For the resilient element 3 with a bent structure, it deforms and stretches when subjected to force. When mounted on the inner side of the latching member 21, the support leg 32 abuts against the front end of the base plate 11, and the bending portion 31 is inserted in the inner notch 211 of the latching member 21. As it deforms and stretches, the side of the movable leg 33 moves in a direction away from the support leg 32, keeping the resilient element 3 in an expanding tendency, and the clearance recess 212 provides a movement space for the movable leg 33. Under the elastic restoring force, the resilient element 3 tends to return to its original bent state, the movable leg 33 approaches the support leg 32, and meanwhile the bending portion 31 of the resilient element 3 arches up to push the latching member 21 to extend outward.

Each clearance recess 212 comprises one or more inclined surfaces extending from the latching member 21 toward the fixed portion 22, such that the radial dimension of the movable portion 23 is smaller than that of the fixed portion 22, allowing the movable portion 23 to swing within the space provided by the base plate 11, and meanwhile providing a movement space for the extension of the movable leg 33 of the resilient element 3.

In addition, the plug-in frame 1 further comprises a cover plate 4. The cover plate 4 is matingly covered and connected with the base plate 11, forming accommodation spaces for isolating the two conductive resilient pieces 2 respectively, and meanwhile providing supporting points for the resilient elements 3. After the cover plate 4, the base plate 11 and the spacing rib 13 are assembled together, a set of conductive resilient piece 2 and resilient element 3 is accommodated on each side of the spacing rib 13 respectively. The front end of the base plate 11 is provided with an upright front baffle 14, and the end of the spacing rib 13 is provided with a mounting gap corresponding to the front baffle 14. A transverse bar 41 extends downward from the front end of the bottom side of the cover plate 4. When the cover plate 4 is covered, the transverse bar 41 is inserted between the front baffle 14 and the spacing rib 13, achieving tight-fitting assembly of the two parts, and forming an exposure opening between the front baffle 14 and the mounting walls 12, which is suitable for the telescopic movement of the latching members 21.

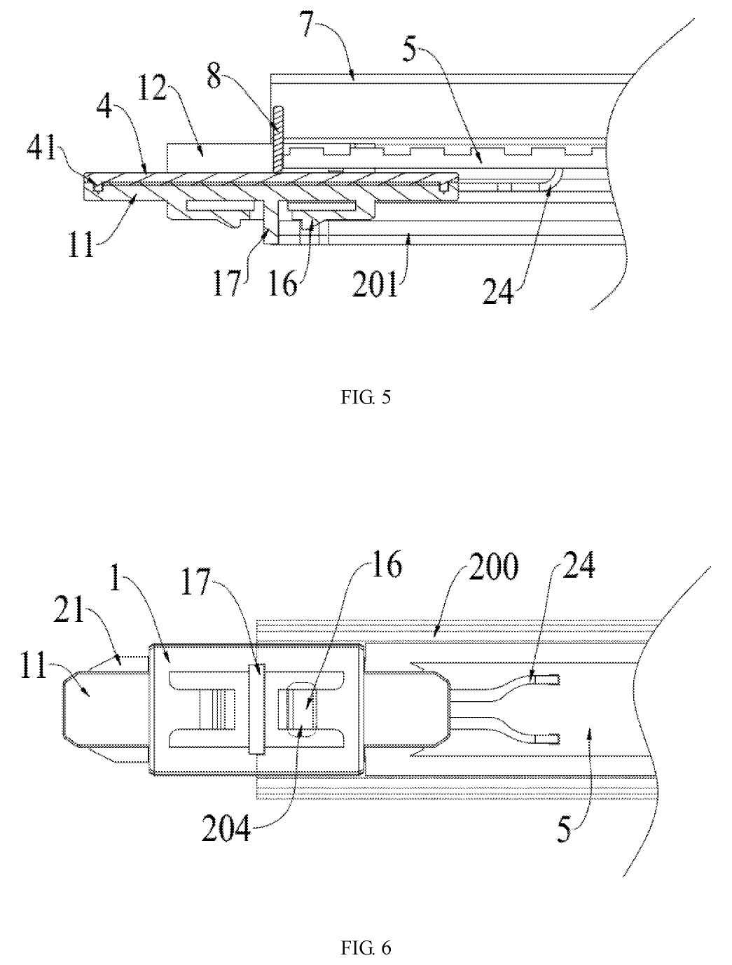

Based on the elastic contact terminal described above, a second aspect of the present application further provides a strip lamp 1000. As shown in FIG. 5, the lamp 1000 comprises a strip-shaped housing 200. An opening is provided at an end of the housing 200 along the length direction, and a strip-shaped circuit board 5 is fixedly assembled inside the housing 200. The aforementioned elastic contact terminal 100 is mounted at the end of the housing 200. The conductive resilient pieces 2 are electrically connected to the circuit board 5 inside the housing 200, and the latching members 21 are exposed outside the housing 200 for interconnection with external components. Further, the tail part of each conductive resilient piece 2 is provided with a pin 24 extending inside the housing 200 along the length direction. The pin 24 of each conductive resilient piece 2 extends beyond the base plate 11 of the plug-in frame 1, and the end of each pin 24 is inserted into a connection hole on the circuit board 5 respectively, followed by electrically connecting the pins 24 to either the positive or the negative circuit of the circuit board 5.

As shown in FIG. 1, the housing 200 comprises a bottom plate 201 and two side walls 202, which are integrally formed. An assembly groove 203 is provided on the inner side of each side wall 202, and a plug-in strip 15 adapted to the assembly groove 203 is provided on the outer side of the plug-in frame 1. One or more plug-in strips 15 may be provided along the outer side of the mounting wall 12 on each side. In addition, a base with a certain strength may be fittingly sleeved outside the housing 200, or the housing 200 may be installed in a track. In an embodiment of the present application, a wire groove is comprised in the assembly groove 203 on each side, and a conductive strip 6 is assembled along the wire groove inside the housing 200. The middle part of each conductive resilient piece 2 is provided with a lateral extension part 25 extending laterally and outwards from the plug-in frame 1. After the plug-in frame 1 is assembled, the conductive resilient piece 2 on each side is electrically connected to the conductive strip 6 via the lateral extension part 25, enabling the lamps to draw power via the conductive strips 6 when cascaded.

The lamp of the present application is suitable for interconnected use of multiple lamps of the same type. When the lamps are interconnected, since a part of the elastic contact terminal 100 of each lamp is located outside the housing 200, it can achieve electrical contact with the conductive strip 6 inside another lamp via the exposed latching member 21. When one of the lamps is powered on, all cascaded lamps can be energized, thereby realizing conduction. Further, the lateral extension length of the latching member 21 for power taking is equivalent to that of the lateral extension part 25, achieving good electrical contact with the conductive strips 6 arranged at the same interval.

FIG. 6 illustrates the bottom structure of the lamp, with the lamp housing shown in a translucent manner to display the components installed inside it. Further, a clasp 16 is provided at the bottom of the plug-in frame 1, and a clasp interface 204 adapted to the clasp 16 is provided on the bottom plate 201 of the housing 200 to maintain a stable connection after assembly. In addition, a limit block 17 is optionally provided at the bottom of the plug-in frame 1; after the plug-in frame 1 is assembled with the housing 200, the limit block 17 abuts against the outside of the housing 200 to further prevent relative movement between the two parts.

The conductive resilient pieces 2 are mounted on and extend along the plug-in frame 1. Specifically, along the length direction, the base plate 11 extends on the plug-in frame 1, and a spacing rib 13 is arranged on the base plate 11. The fixed portion 22 at the middle part of each conductive resilient piece 2 is mounted between the spacing rib 13 and the mounting wall 12. Optionally, the width of the fixed portion 22 is equivalent to the gap width between the spacing rib 13 and the mounting wall 12, so that the conductive resilient piece 2 can be clamped therebetween. Both ends of the base plate 11 along the length direction extend beyond the mounting wall 12, and allow the latching member 21 and the lateral extension part 25 to protrude laterally. Preferably, the latching member 21 and the lateral extension part 25 extend outward from the front and rear ends of the mounting wall 12 along the length direction respectively, so that the conductive resilient piece 2 clamps the mounting wall 12, and the forward and backward movement of the conductive resilient piece 2 on the plug-in frame 1 is restricted.

Preferably, the conductive resilient pieces 2 and the conductive strips 6 are located on the same mounting plane. A side of the lateral extension part 25 facing the tail part of the conductive resilient piece 2 is provided with an inwardly inclined guide surface, which guides the conductive resilient piece 2 to abut against the conductive strip 6 when the plug-in frame 1 is assembled. The circuit board 5 is installed along the assembly groove 203 of the housing 200, and may not be located on the same mounting plane as the conductive resilient pieces 2; the pins 24 of the conductive resilient pieces 2 are bent before passing through the circuit board 5.

LED chips 51 are mounted on the circuit board 5 of the lamp 1000. The lamp 1000 further comprises a lamp cover 7 arranged in the light-emitting direction of the LED chips 51. Optionally, the lamp cover 7, the side walls 202 and the bottom plate 201 are integrally formed to form the housing 200. A partition plate 8 may also be provided at the end of the housing 200 to isolate the circuit board 5 from the outside. Optionally, a mounting column is provided on the partition plate 8, which is adapted to the mounting hole at the end of the circuit board 5, so that the partition plate 8 is fixedly mounted relative to the circuit board 5.

When in use, to facilitate docking and interconnection, a guide inclined surface 213 is provided at the end of the latching member 21. Thus, when inserting through the elastic contact terminal 100, the guide inclined surface 213 is first squeezed inward by force, causing the latching members 21 on both sides to contract inward. After being installed in place, the latching members 21 remain in the expanded (latching) state under the reset force of the resilient elements 3, so that the conductive resilient pieces 2 can maintain stable electrical connection when interconnected with external lamps.

The above are only preferred embodiments of the present invention, and are not used to limit the protection scope of the present invention. Any modification, equivalent replacement or improvement within the spirit of the present invention is covered by the scope of the claims of the present invention.

What is claimed is:

1. An elastic contact terminal for the end of a lamp, comprising a plug-in frame (1) adapted to be matingly connected to an end of a housing (200) of the lamp, wherein
the plug-in frame (1) is provided with two conductive resilient pieces (2) at intervals, and
the conductive resilient pieces (2) extend along the length direction of the housing (200); wherein
the length of the conductive resilient pieces (2) is greater than that of the plug-in frame (1), and each of the conductive resilient pieces (2) comprises a latching member (21) exposed out of the plug-in frame (1);
the latching members (21) of the two conductive resilient pieces (2) are configured to be displaced relative to each other to expand and contract;
each of the opposite inner sides of the latching members (21) is in contact with a resilient element (3), and
the resilient element (3) is configured to cause the latching members (21) to tend to expand outward by virtue of its deformation restoring force.

2. The elastic contact terminal as claimed in claim 1, wherein the conductive resilient piece (2) comprises a fixed portion (22) and a movable portion (23); the fixed portion (22) is fixedly mounted in mating engagement with the plug-in frame (1); the movable portion (23) is connected between the fixed portion (22) and the latching member (21) along the length direction; and the plug-in frame (1) is provided with a clearance for the movable portion (23), enabling the movable portion (23) to swing along the width direction.

3. The elastic contact terminal as claimed in claim 1, wherein the plug-in frame (1) comprises a base plate (11) and mounting walls (12); the base plate (11) is arranged to extend along the length direction of the housing (200); the conductive resilient piece (2) is mounted on the base plate (11); the mounting walls (12) are vertically arranged on both sides of the base plate (11) and are matingly connected to the inner side of the housing (200).

4. The elastic contact terminal as claimed in claim 3, wherein the base plate (11) is provided with a spacing rib (13) protruding therefrom; the spacing rib (13) extends along the length of the housing (200), and each of the two conductive resilient pieces (2) is mounted on a respective side of the spacing rib (13) and is positioned between the spacing rib (13) and one of the mounting walls (12), and a resilient element (3) is disposed on each side to abut against the spacing rib (13) and the conductive resilient piece (2).

5. The elastic contact terminal as claimed in claim 1, wherein each of the opposite sides of the two latching members (21) along the width direction is formed with an inner notch (211), and the resilient element (3) abuts against the inner notch (211) and is configured to urge the respective latching member (21) to expand outward; a clearance recess (212) is formed extending from the inner notch (211) in a direction away from the end of the latching member (21), and is configured to provide an accommodation space for the resilient element (3) when the resilient element (3) is compressed and deformed.

6. The elastic contact terminal as claimed in claim 5, wherein the middle part of the resilient element (3) is provided with a bending portion (31) configured to abut against the inner notch (211) of the latching member (21); one end of the resilient element (3) is a support leg (32) configured to establish a supporting point in the plug-in frame (1), and the other end is a movable leg (33) configured to move within the clearance recess (212) along with the elastic deformation of the resilient element (3); the resilient element (3) is configured to be capable of expanding under force and has a tendency to make the movable leg (33) approach the end of the support leg (32) under the action of deformation restoring force.

7. The elastic contact terminal as claimed in claim 5, wherein the clearance recess (212) comprises one or more inclined surfaces extending from the latching member (21) toward the fixed portion (22), such that the radial dimension of the movable portion (23) is smaller than that of the fixed portion (22).

8. The elastic contact terminal as claimed in claim 4, wherein the plug-in frame (1) is further provided with a cover plate (4), the cover plate (4) and the base plate (11) engage to form accommodation spaces for isolating the two conductive resilient pieces (2) respectively, and to provide supporting points for the resilient elements (3).

9. A strip lamp comprising a strip-shaped housing (200), wherein
an opening is provided at an end of the housing (200) along the length direction, and
a circuit board (5) is fixedly assembled inside the housing (200),
characterized in that the elastic contact terminal according to claim 1 is mounted at the end of the housing (200), the conductive resilient pieces (2) are electrically connected to the circuit board (5) inside the housing (200), and the latching members (21) are exposed outside the housing (200).

10. The strip lamp as claimed in claim 9, wherein a tail part of each conductive resilient piece (2) is provided with a pin (24) extending inside the housing (200) along the length direction; the end of the pin (24) of each conductive resilient piece (2) is inserted into a connection hole on the circuit board (5) respectively, so as to be electrically connected to either the positive or the negative circuit of the circuit board (5).

11. The strip lamp as claimed in claim 10, wherein the housing (200) comprises a bottom plate (201) and two side walls (202); an assembly groove (203) is provided on the inner side of each side wall (202), and a plug-in strip (15) adapted to the assembly groove (203) is provided on the outer side of the plug-in frame (1); a wire groove is provided in the assembly groove (203) on each side, and a conductive strip (6) is assembled along the wire groove inside the housing (200); the middle part of each conductive resilient piece (2) is provided with a lateral extension part (25) extending laterally outwards from the plug-in frame (1), wherein, when the plug-in frame (1) is assembled, the conductive resilient piece (2) on each side is electrically connected to the conductive strip (6) via the lateral extension part (25).

12. The strip lamp as claimed in claim 11, wherein the conductive resilient piece (2) and the conductive strip (6) are located on the same mounting plane, and a side of the lateral extension part (25) facing the tail part of the conductive resilient piece (2) is provided with an inwardly inclined guide surface.
